(19) United States
(12) Patent Application Publication
(10) Pub. No.: US 2009/0307527 A1
(43) Pub. Date: Dec. 10, 2009

(54) DATA RETRIEVAL AND HANDLING SYSTEMS, VIRTUAL WAREHOUSING, PRICE COMPARISON, PRICE AGGREGATION AND STOCK AVAILABILITY ENGINE

(76) Inventors: Peter M. Robbins, West Midlands (GB); Ian Stone, West Midlands (GB)

Correspondence Address: LAW OFFICE OF JAMES TROSINO, P.O. BOX 200, YONKERS, NY, 10703, US

(21) Appl. No.: 12/373,292

(22) PCT Filed: Jul. 10, 2006
(86) PCT No.: PCT/GB06/02545

§ 371 Date: Jul. 3, 2009

(30) Foreign Application Priority Data
Jul. 11, 2006 (EP) 06116962.9

(51) Int. Cl. G06F 11/07

(52) U.S. Cl. 714/15; 714/57; 714/54; 714/E11.023; 714/E11.024

(57) ABSTRACT

Systems in accordance with this invention obtain data over a plurality of networks from a plurality of sources which enable accurate analysis of data so obtained and subsequent manipulation and storage of the data. In particular, but not exclusively, systems in accordance with this invention relate to virtual warehousing of products as well as price comparison, price aggregation, and stock availability engines.

The invention relates to systems for obtaining data over a plurality of networks from a plurality of sources which enables accurate analysis of data so obtained and subsequent manipulation and storage of the data. In particular, but not exclusively, the invention relates to virtual warehousing of products as well as price comparison, price aggregation, and stock availability engines.

The invention particularly relates to product cataloguing or warehousing, in which sector it is known for each product to be provided with certain common identifiers. One such identifier is the SKU (stock keeping unit) which is a string of alpha numeric characters intended to be unique for each new product. However, the SKU system is not universally applied and accordingly it is not possible to use the system for all products from different manufacturers and/or product sectors. Other identifiers exist such as barcode data on packaging which barcode data can also be represented in an alpha numeric manner or digitally for use in an electronic product cataloguing system. However, again the barcode data is not necessarily unique for each product across all manufacturers and/or product sectors.

It should be appreciated that the use of the term product throughout this specification is intended to include merchandisable items including products and/or services such as a banking or legal service or other commodity.

Moreover, there is a problem of firstly obtaining product data in a variety of formats from different product suppliers and retrieving this data through a variety of communication networks such as dial-up and/or online access to remote databases, followed by the problem of identifying accurately the nature of each product from a supplier once the data has been obtained and interpreted. Accordingly, significant technical issues exist relating to data retrieval and interpretation in order to optimize communication between the product cataloguing system and the remote databases, as well as optimizing data storage at the product cataloguing system.

Accordingly, the invention seeks to avoid or at least mitigate problems in the prior art and according to one object of the invention is to seek to optimize data storage of product information to enable accurate manipulation of product information.

According to a first aspect of the invention there is provided a system for obtaining and verifying data from a plurality of remote sources via one or more communications channels or networks, each source having a database of product information comprising a plurality of fields of data associated with each product available from the source, the system enabling analysis of the data from each of the sources to determine a common product identifier for each product, the system being adapted to compare the determined common product identifier with a predetermined set of common product identifiers and in the event of a failure to match the common product identifiers to enable an effective alert to a user that the data associated with a product is invalid for example by rejecting the data, placing the data in a special database and/or effecting a message to a user of the failure.

Other aspects and features of the invention are set out in the accompanying claims at the end of the specification.

An embodiment of the invention will now be described, by way of example only, with reference to the accompanying drawings, in which:

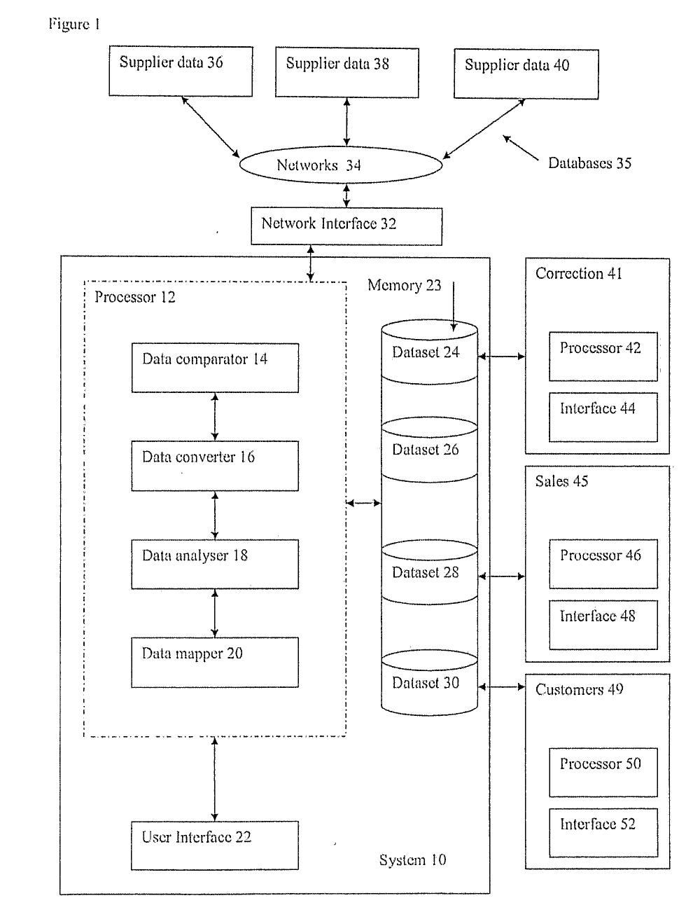

FIG. 1 is a schematic block diagram of a system according to the invention in communication with certain peripheral systems;

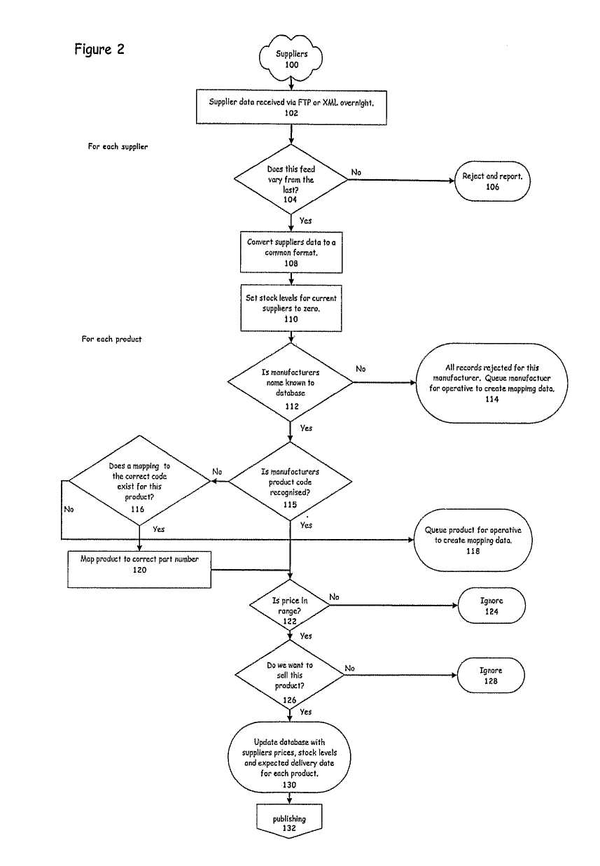

FIG. 2 is a schematic flow diagram showing the capture of data from various suppliers;

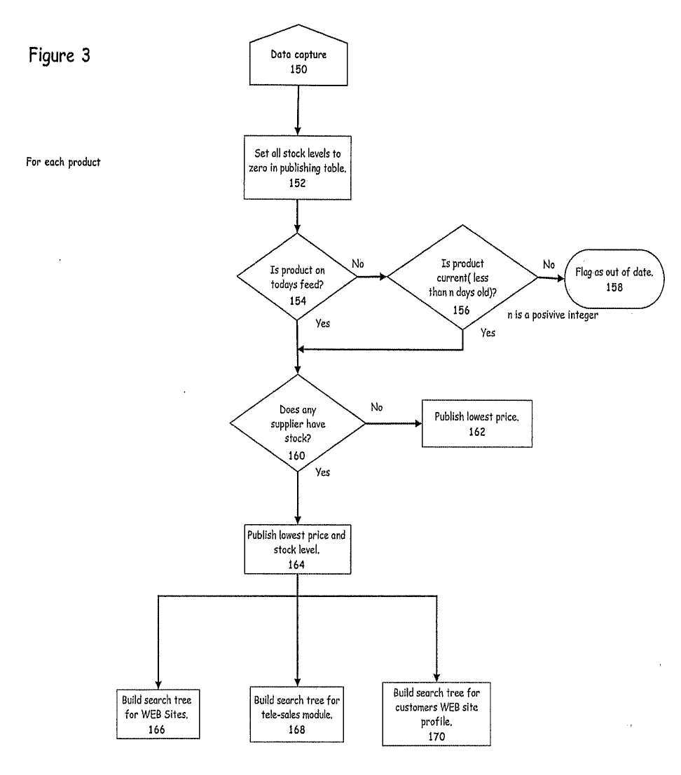

FIG. 3 is a schematic flow diagram of the process of publishing data;

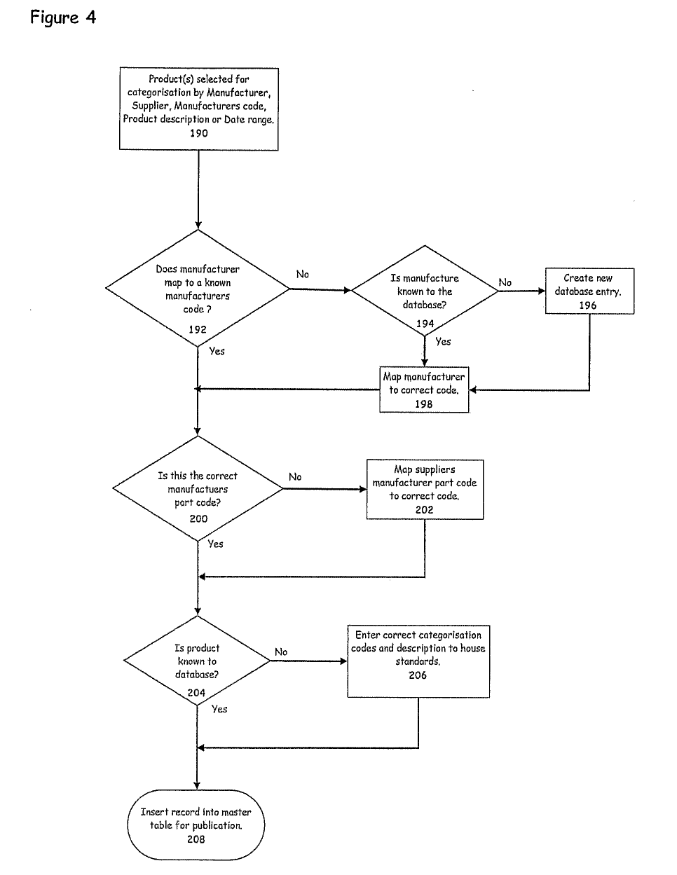

FIG. 4 is a schematic flow diagram related to categorization of unknown products;

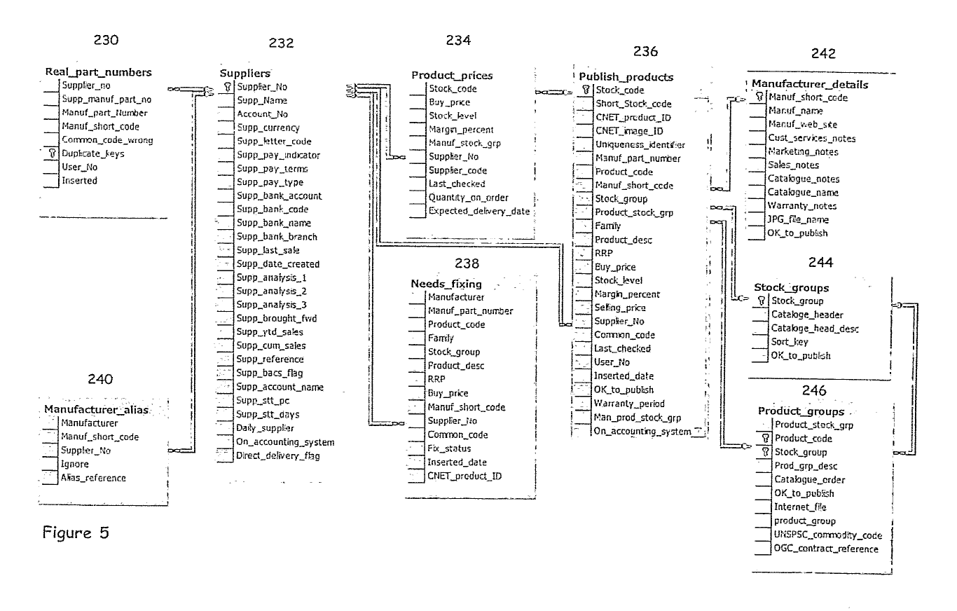

FIG. 5 is a schematic representation of different databases used by the system;

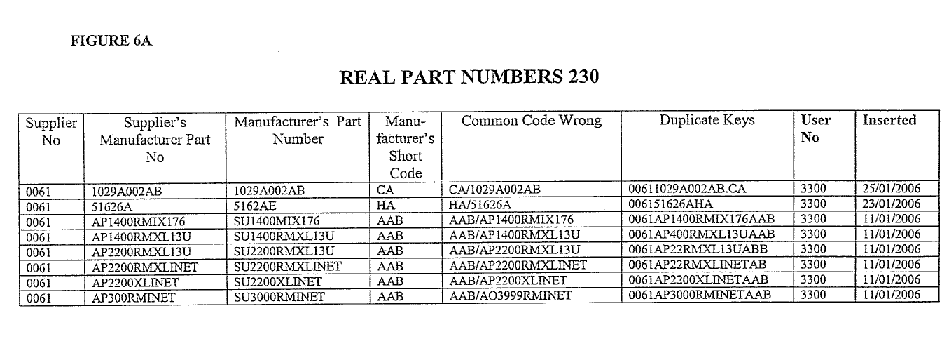

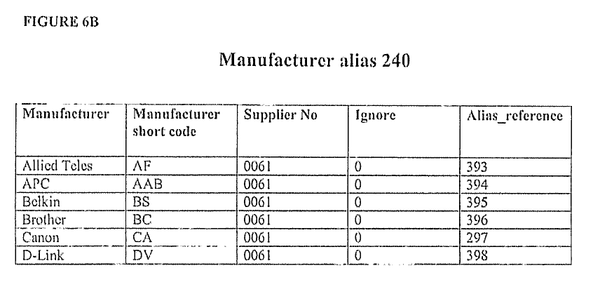

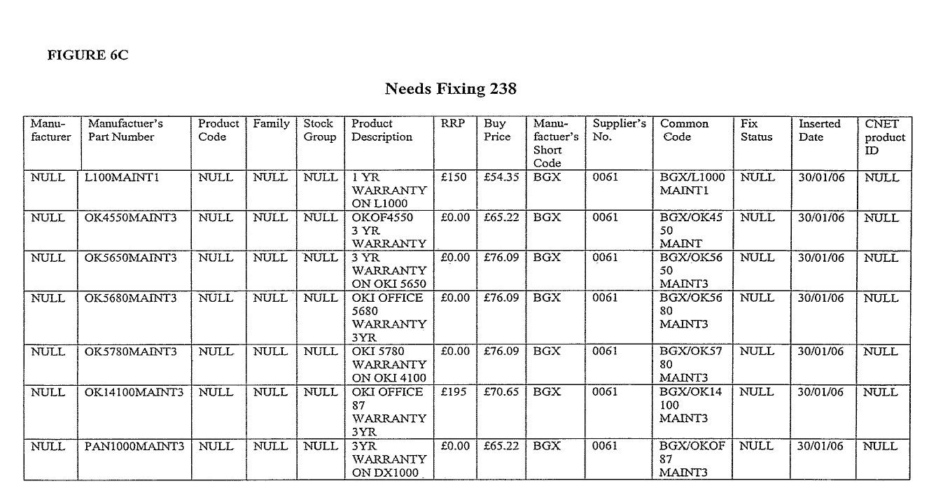

FIG. 6 provides examples of different data sets used within the databases;

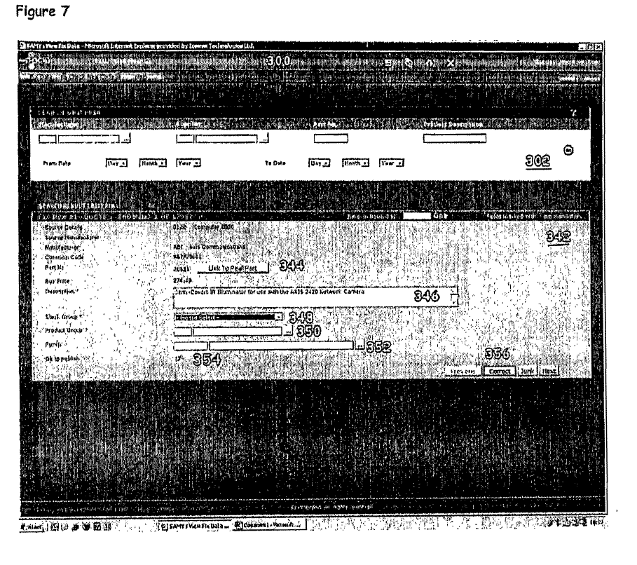

FIGS. 7, 8, 9, 10 and 11 provide different views of a user interface enabling correction of erroneous data.

With reference to FIG. 1 there is shown a system 10 according to the invention comprising a processor 12 being adapted to enable certain functionality including a data comparator 14, a data converter 16, a data analyzer 18 and a data mapper 20, as described in more detail later. Processor 12 is operably in communication with a user interface 22, for a system user (super user or administrator), comprising for example a keyboard and other peripheral devices as appropriate. System 10 further comprises a memory or data store 23 enabling storage of a number of at least one database, a number of databases and/or datasets including dataset 24, dataset 26, dataset 28 and data 30 which may or may not be accessible by third parties remote from the system 10. That is, the memory 23 can store data for a database application such as an Oracle, Microsoft SQL Server, or database application which is able to run on processor 12. The data which is stored can be in a variety of formats including separate datasets and/or separate data sheets within a single set of data. A preferred format for the data is discussed in more detail later in relation to FIG. 5 but in the preliminary description of the system, data is referred to as forming part of one or more of datasets 24, 26, 28 or 30.

System 10 further comprises a network interface 32 in communication with a number of networks 34 which may require various communication processes and/or protocols including dial-up and/or online access to a number of remote product sources comprising databases 35 including supplier data such as supplier data 36, supplier data 38 and supplier data 40. The number of suppliers can vary from just a few to many hundreds or indeed thousands.

Beneficially therefore the network interface 32 is adapted to enable communication by system 10 with remote databases 35 and enable retrieval of data in pre-determined (but varied) formats ready for processing by a processor 12. Beneficially, system 10 is adapted to enable retrieval of data at pre-determined intervals and in one scenario, the data can be newly obtained in batches over a very brief period such as an hour or two between say 3.00 a.m. and 5.00 a.m. in the morning thereby enabling updating of data held in memory 23 on system 10 when the system 10 is unlikely to be needed for other users.

Before allocating newly obtained data from the suppliers into local datasets in memory 23, the data is first processed by processor 12 as described in relation to FIGS. 2, 3 and 4 to enable such an allocation to the appropriate datasets and hence interaction with a variety of users including a system user via user interface 22, a data corrector or operative who interfaces with the data in memory 23, eg at dataset 24, via a processor 42 and user interface 44 using a correction system 41, a sales representative who accesses data in memory 23, eg at dataset 28 via a processor 46 and interface 48 using a sales system 45, and a customer who accesses data eg in dataset 30 via a processor 50 and interface 52 using customer system 49, as described in more detail later on.

Referring to FIG. 2, the preferred data retrieval step 102 of retrieving supplier data in FTP or XML denotes overnight from a supplier 100 is shown. The data obtained from each supplier is compared with data held in dataset 26 for that supplier to determine if there is any difference in the data stored with the newly acquired data. If data comparator 14 determines that there is no difference in the data then the new data is simply rejected and a report provided to the system user via user interface 22 that this event has occurred as indicated at process step 106 in FIG. 2.

If there is a change in the data from supplier 100, data converter 16 converts the data into a common format as indicated in step 108. The product information held for that supplier in dataset 26 is then adjusted to set stock levels for the current supplier to zero as indicated at step 110. The manufacturer of the product from the supplier is then identified at step 112. If the manufacturer is not known then the data is rejected as shown in step 114 and the data is queued in dataset 24 to enable an operative to create mapping data for that manufacturer. If however, the manufacturer is known, then the data analyzer 18 checks to determine if a manufacturer product code is recognized as step 115. If it is not, data analyzer 18 checks a mapping database in order to ascertain if a correct code exists for the product as indicated at step 116. A description of the mapping data and inter relationship with other data is described later in relation to FIG. 5. If no mapping can be found, the data is rejected and queued for an operative to create mapping data as indicated at step 118. If, however, a correct mapping code can be automatically determined at step 116 via data mapper 20, as indicated at step 120, the data is automatically amended to map the product to the correct product part number for that manufacturer and the process moves onto step 122 which ascertains if the price is within a predetermined range eg a percentage of a lowest price or range of lowest prices. If not, the data is rejected as indicated at step 124. If it is within the pre-determined range identified at step 122, then processor 12 determines whether or not it is in fact desirable to sell the product as indicated at step 126; if not, the data is rejected as indicated in step 128, but if it is, the databases are updated with all the appropriate information as indicated at step 130 and the data is indicated as being allowable for publishing as indicated at step 132.

It should be appreciated that one of the suppliers whose data can be analyzed could in fact be the company operating system 10. Accordingly, in the circumstances that system 10 is not used entirely as a “virtual warehouse”, it is possible for the company to hold stock of its own and therefore to input data into system 10 related to that stock. There are a number of ways of publishing data from the different suppliers including the company operating system 10, to potential customers and in one form the system can automatically set the price of the system operator's stock to be equal to the lowest price available for the identical product in order that customers obtain the system operator's stock product at the best available price therefore providing the customer with the desired benefit of system 10 whilst also reducing the system operator's stock (which might for example be held only due to returns from previous orders taken over the virtual warehousing system). Accordingly, when customers place orders through the customer interface 49, it is possible to specify an order of sale based on system operator stock, stock from suppliers who ship directly to the customer, suppliers who ship to the system operator, and then orders which cannot be fulfilled using the system which require user intervention such as a telephone call from a sales representative.

The sequence of events for publishing the data is shown schematically in FIG. 3 whereby the data captured through the sequence described in relation to FIG. 2 to the publishing process at step 150 is developed. In the event of data passing through to step 152, all stock levels are set to zero for the product in the publishing table which is held in dataset 28. At step 154 it is determined if the product is on todays feed if no, it is determined if the product is current, that is less than a pre-determined number of days (n being a positive integer) old as provided by step 156. If not, the product is indicated as being as out of date as indicated in step 158. If however, the product is either in today's feed (ie a check is made to see if the date the feed was received equals the current date) and/or less than the pre-determined number of days n old then processor 12 analyses the data to determine if the supplier has stock as indicated at step 160. If not, the system simply publishes the lowest price at step 162 without any stock level information (and indicates that the stock level is zero).

In the event that there is stock however, then the lowest price is published together with the stock level as indicated at step 164. Subsequently, the processor 12 builds a search tree for websites at step 166 which data is accessible through dataset 30. Similarly processor 12 builds a search tree for tele-sales module as indicated at step 168 which tele-sales data is available through dataset 28 to sales representatives interacting with system 10 via processor 46, and processor 12 builds a search tree for customer website profile as indicated in step 170 which data is also held at dataset 30 shown in FIG. 1.

With reference to FIG. 4 there is shown schematic steps of amending data rejected at steps 114 or 118 in FIG. 2. At step 119 the products stored in database 24 are selected by manufacturer, supplier, manufacturers code, product description or data range as appropriate. This can be seen visually from the interface shown in FIG. 7 which might be displayed at an operative user's interface 44 shown in FIG. 1.

At step 192 it is determined if the manufacturer for the selected data maps to a known manufacturers codes if no, it is determined if the manufacturer is known to the database at step 194; if no again, then an operative creates a new data entry for that manufacturer together with a new manufacturer's code at step 196. Subsequently if the manufacturer is known to the database and/or a new entry is made the data is mapped to the correct manufacturer code at step 198.

At step 200 it is determined if the correct manufacturer's part code has been identified from the data, if no, then an operative determines at step 202 the correct manufacturer part code and the data is mapped to this correct manufacturer part code.

At step 204 it is determined if the product is known to the database, if no, then the correct product categorization codes and description are added to house standards at step 206. Subsequently data is inserted into the record for the master table ready for publication in the dataset 26 to enable subsequent processing through the publishing process described earlier in relation to FIG. 3.

Accordingly, it will be appreciated that database held in memory 23 stored locally on system 10 comprise various sets or sub-sets of the overall data which is deemed appropriate to be stored. The primary, or full set of data is held at dataset 26 and individual product data can be mapped across supplier, manufacturer and real part numbers etc. as shown in FIG. 5. Sub-sets of this data where errors in the data have been identified in the processes described already, are stored in dataset 24 whereas different sub-sets of the data for publication to sales representatives and to customers are published in datasets 28 and 30 as also already described. With reference to FIG. 5, this process and structure can be seen in greater detail. FIG. 5 provides an overview of the data which is stored in memory 23. FIG. 5 shows the titles for different datasets and the columns of fields contained within the dataset. Accordingly, table 232 entitled suppliers, comprises 28 columns of data related to each supplier including supplier number, supplier name and account number and so on. One of the tables is entitled real part numbers, table 230, which comprises 8 columns of data including the unique supply number (as found from the data related to table 232), the supplier's manufacture part number and the original manufacturer's part number. Table 230 further comprises columns of data for each product comprising the manufacturer's short code (see table 242 described later), and a common code wrong column, as well as duplicate keys, user number and inserted column.

Beneficially, the common code wrong table enables mapping of data received and analyzed at step 116 shown in FIG. 2. The common code wrong can be a code number which is frequently used by one or more suppliers and/or an automatically generated code based on a combination of components such as alpha numeric strings representative of the original manufacturer, and a code or short form of the original manufacturer's name, an abbreviation for the manufacturer, manufacturer's name, the suppliers name and/or abbreviation, in combination with the manufacturer's part number. For example, the common code wrong can in one form be a concatenation of a manufacturer's code and a “/” and the supplier's interpretation of a manufacturer's part number. Accordingly, a dataset related to the real parts numbers table 230 enables automatic identification at step 116 using the data mapping function 20 of processor 12 in order to assign the unique manufacturer's product code at step 120 in FIG. 2. Beneficially also, matches using the real part number dataset related to table 230 can be achieved through combinations of matches of one or more columns, such as having the correct supplier number, supplier manufacturer's part number and manufacturer's short code within the incoming data (step 102 at FIG. 2) enables correct identification of the manufacturer's part number. Table 240 entitled manufacturer alias comprises 5 column titles namely the manufacturer's name, the manufacturer's short code, the supplier number, and ignore column and alias reference.

Data held within a dataset related to manufacturer alias is an association of the manufacturer's name with a manufacturer's short code as used by a given supplier as identified by the supplier number hence assisting in the mapping function related to the real parts number data referred to in table 230.

Further tables shown in FIG. 5 include the product prices, table 234, which comprises 9 columns of data including the stock code, buy price, stock level, manufacturer's stock group, supplier number, supplier code, last checked, quantity on order and expected delivery date.

Table 238 refers to data which needs fixing, as previously referred to as dataset 24. The data held within dataset 24 comprises the following columns, the manufacturer's name, the manufacturer's part number, the product code (where of course any of these are known in relation to the corrupt or otherwise erroneous data), family, stock group, product description (which is an alpha numeric/natural language (such as English) description of the nature of the products the recommended retail price, the buyer price, the manufacturer's short code, supplier number, the common code, the fixed status (whether or not the fix has been implemented or not) the inserted date (when corrupt data was first identified) and a CNET product ID. A dataset 24 as described earlier and is corrected using the correction system 41 described in relation to FIGS. 7 to 11.

Within the categorization system described in this example, the use of a “stock group” is used as the highest level of categorization of each product. Table 244 shows the columns associated with the stock group data which include the stock group itself, which might be identified using an alpha numeric string, a catalogue header, which might comprise a simple description of the stock group such as for example appropriate printer suppliers, security, data storage, media, maintenance products, software, printers, and so on. Catalogue head description, short key, and whether or not the data is OK to publish.

The next level of categorization is that of product groups as identified in table 246. Data associated with the products group comprises the columns of product stock group (possibly a combination of alpha numeric strings such as product code and stock group), the product code itself (again possibly an alpha numeric string representative of an individual type of product such as printer goods, and anti glare columns, or anti static mats for example), the stock group (taken from those identified in relation to the dataset for table 244). Also given is the product group description (a real language description of the product for example in English such as the term “magnetic tape” to describe such products), catalogue order, OK to publish, internet file and product group.

Additionally, table 242 provides manufacturer's details. The columns in the dataset related to the manufacturer's details include the following columns: the manufacturer's short code, the manufacturer's name, the manufacturer's website, the customer service notes, marketing notes, sales notes, catalogue notes, catalogue name, warranty note, JPG file name and OK to publish.

Finally, the published products table 236 is provided comprising some 26 columns including the stock code, short stock code, CNET product ID, CNET image ID, uniqueness identifier, manufacturer part number and so on. Data associated with table 236 is able to be published to customers and has proved to be referred to as dataset 30 for example.

Referring to FIG. 6, sample entries in a dataset related to the real part numbers is shown in FIG. 6A comprising the supplier number, the supplier's manufacturer's part number, manufacturer's part number, manufacturer's short code, common code wrong, duplicate keys and user number and inserted date. As can be seen, the common code wrong can comprise a combination of the manufacturer's short code with the manufacturer's part number separated by a“/”.

FIG. 6B shows data associated with the manufacturer's alias table 240 including the manufacturer, manufacturer's short code, supplier number, ignore, and alias reference. Accordingly, it can be seen that supplier number 61 (which relates to a supplier as identified in the dataset associated with table 232 described earlier, refers to manufacturer Allied Teles with the manufacturer's short code AF. FIG. 6C shows data shown associated within the needs fixing table 238. As shown, columns include manufacturer, manufacturer part number, product code, family, stock group, product description, RRP, buy price, manufacturer's short code, supplier number, common code, fix status, inserted date and CNET product ID. Referring to FIG. 6 there is shown small sets of data showing the different columns associated with each of the tables shown in FIG. 5.

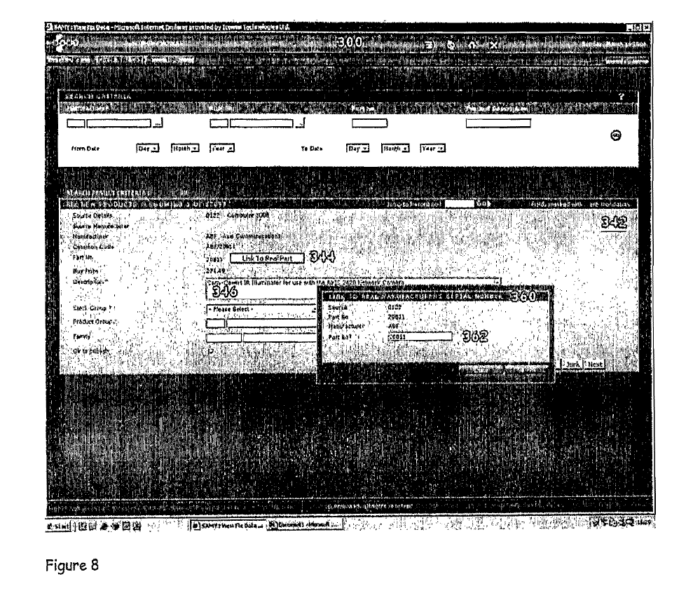

Referring to FIGS. 7 to 11, a template or pane 300 is shown forming part of a graphical user interface with an operative for interaction with dataset 24 via processor 42 and interface 44 as shown in FIG. 1. The template 300 comprises a search criteria selector 302 enabling searching of dataset 24 by manufacturer, supplier, part number, product description and between specified dates. The results of the search are shown in the view panel 342 which indicates for example that the first product of 17057 products in dataset 24 is represented in the display 342. The source details are given as 0122 Computer 2000 source manufacturer is not known, the manufacturer however is indicated as ABF Axis Communications and a common code ABF/20811 is indicated. The part number is indicated as 20811 and a button 344 is provided in order to enable an operative to link the part number with a real part number for that product. The buying price of the product is also indicated together with a description of the product in display 346. The stock group is correctable via a drop down menu 348 as is the product group and family at data input 350 and 352 shown in FIG. 7. Finally a tick box 354 is provided to enable the operative to indicate that the data is now ready for publication and the operative is provided with a series of options and buttons 356 to enable scrolling through the data through the next buttons, correction of the data held in dataset 24 through use of the correct button and/or final rejection of the data through use of the junk button. Beneficially therefore, the user is able to be assigned batches of products to describe and categorize using any of the criteria manufacturer, supplier, manufacturer of product code, product description and/or date range to enable operable processing of the data and subsequent reduction of data stored in dataset 24 and optimization of complete data held within dataset 26. Referring to FIG. 8, template 300 is shown comprising data related to a product in the display 342. However, a further pop-up 360 is shown enabling a link to be made between the identified product and a real manufacturer part number which can be entered in the data input box 362. The pop-up 360 is generated by the operative pressing on button 344. This feature is particularly beneficial since the suppliers often modify the manufacturers product code and the pop-up is used to link the suppliers errors to the real code and moreover the suppliers product description is sometimes misleading and can be overridden in the data input panel 346 in order to bring the description into line with the company standards.

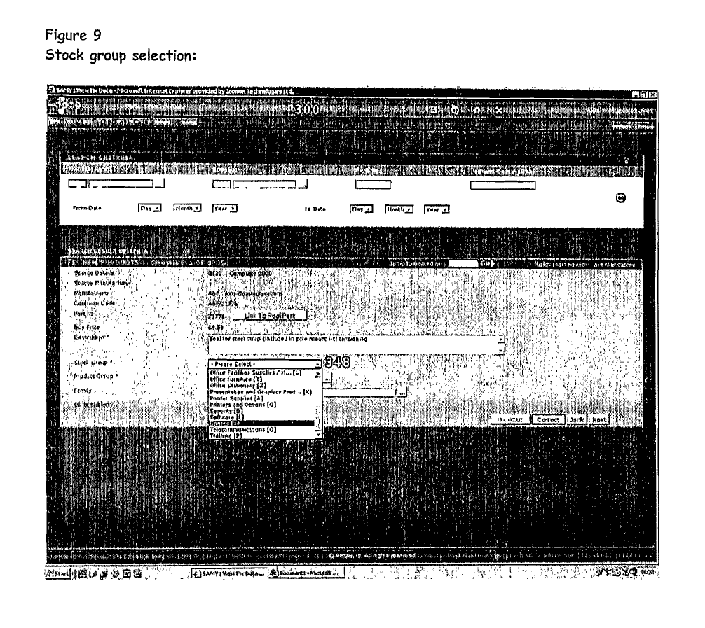

Referring to FIG. 9, template 300 is again shown having a product identified in section 342 whereby the stock group for the product can be corrected using drop-down button 348. Preferably, this stock group is the highest level of product categorization as indicated in table 244 shown in FIG. 5.

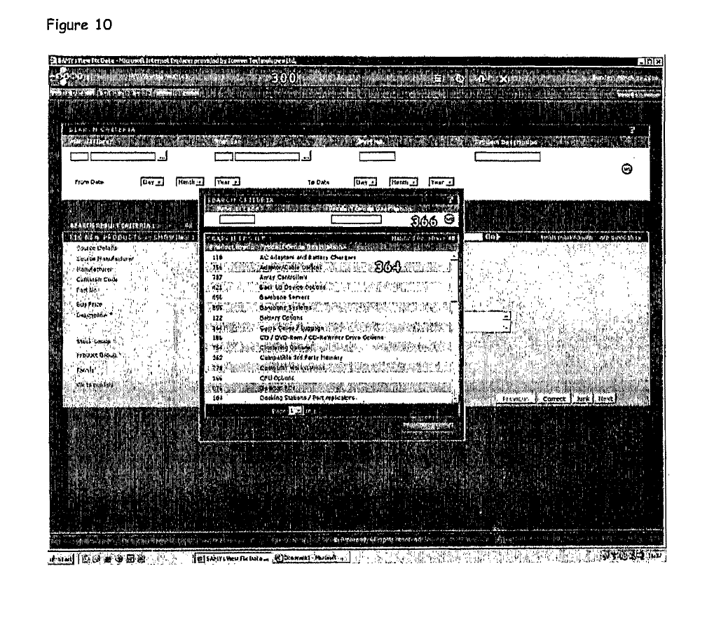

Referring to FIG. 10, a pop-up 364 is shown to enable selection of the product group which is a sub-set of the stock groups. Here, it can be seen that the product is able to search for the appropriate products group using search criteria including product code and product group description which can be entered through data entry section 366.

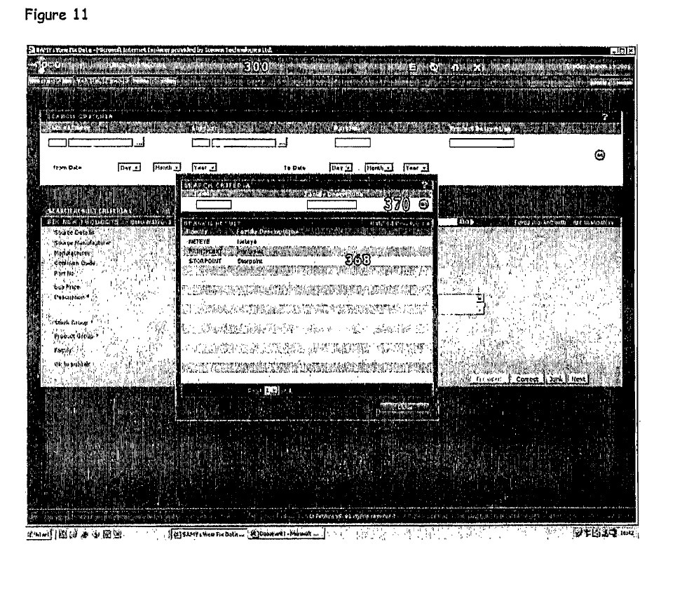

Referring to FIG. 11, there is shown a pop-up 368 enabling selection of the manufacturer's of family to be entered at data entry 352 shown in template 300 in FIG. 7. Search criteria including family description are available through data input section 370 of pop-up 368 and the user is thereby able to search and identify the appropriate family for the product in order to complete the data associated with the previously arranged data held for the product. Data so corrected via these interfaces is then inserted into the master table as indicated at step 208 in FIG. 4.

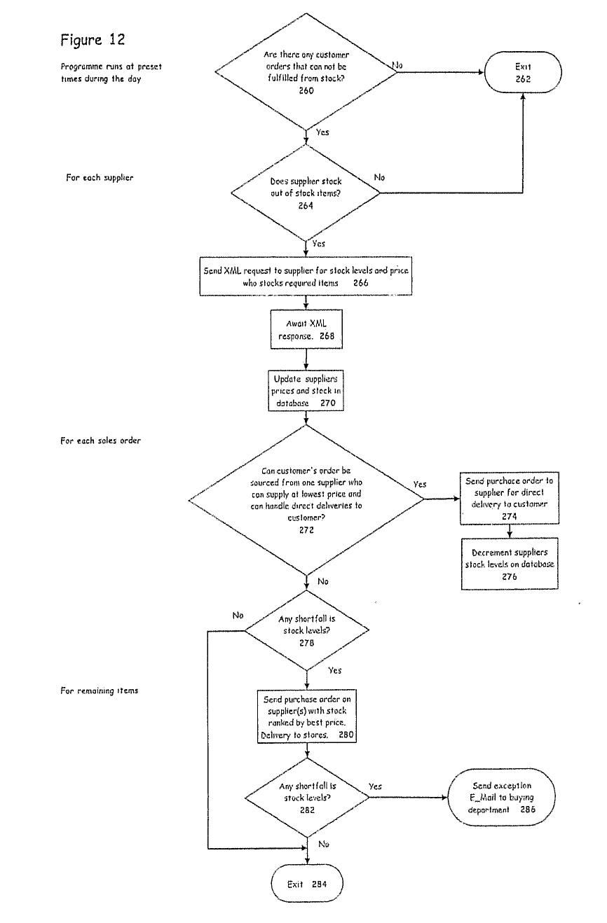

Finally, with reference to FIG. 12, system 10 carries out an online price and stock level check across all suppliers where orders cannot be fulfilled from stock at step 260. Accordingly, system 10 identifies if there are any customer orders which cannot be fulfilled from stock at step 260. In other words, if system 10 identifies that a given product is not available from any of the suppliers based on the most recently received supplier data (see FIG. 1 for example), or in one specific version, from the stock held by the system operator (as discussed earlier in relation to FIG. 2 such as returned stock from earlier orders placed over the virtual warehousing system 10), or alternatively, from the stock indicated as available from those suppliers who ship directly to customers without going via the operator of system 10.

If there are no such unfulfilled orders, then the system simply exists this routine at step 262. If yes, system 10 can determine which of one or more suppliers stock the requested item as indicated at step 264 if there are no suppliers of the requested item then again the system exists at step 262. However, assuming one or more suppliers is identified at step 264, then the system sends a request for example in the form of an XML request to the supplier for stock levels and pricing information (amongst other things) related to the requested stock item at indicated at step 266. The system awaits a response, again potentially in the form of XML response as indicated at step 268. The system then updates the supplier data including the supplier's prices and stock in the database memory 23 as indicated in step 270. The system enquires at step 272 if a customer's order can now be completed using a supplier who supplies at the lowest price and can handle direct deliveries to the customer. If yes, a purchase order is sent to the supplier for direct delivery to customer as indicated step 274 and the database is suitably amended to decrement the supplier's stock levels as indicated at step 276.

However, if the only criterion for the failure to complete the order at step 272 is the stock level, as indicated at level 278, then one or more purchase orders are generated to one or more suppliers with stock ranked by best according to the received data at step 268. At step 280 any outstanding items are ordered from any supplier with stock for delivery to stores. Accordingly, stock levels are incremented at step 280.

As indicated at step 282, it is then assessed if there are any further shortfalls if no, then the system exists at step 284 but if yes, an exception message is sent for example by email to a buying department as indicated at step 286.

1. A system for obtaining and verifying data from a plurality of remote sources via one or more communications channels or networks, each source having a database of product information comprising a plurality of fields of data associated with products available from the source, the system enabling analysis of the data from each of the sources to determine a common product identifier for each product, the system being adapted to compare the determined common product identifier with a predetermined set of common product identifiers and in the event of a failure to match the common product identifiers to enable an effective alert to a user that the data associated with a product is invalid for example by rejecting the data, placing the data in a special dataset and/or effecting a message to a user of the failure.

2. A system according to claim 1 adapted to process data and store erroneous data associated with a product in a separate dataset to a main dataset for data determined to be acceptable, whereby the erroneous dataset comprises only data for products having an erroneous field of data associated therewith.

3. A system according to claim 2 comprising a dataset of erroneous data and a user interface to enable an operative to select data held within the erroneous dataset for correction based on one or more selection criteria.

4. A system according to claim 3 wherein the selection criteria is selectable from at least one of selection of a period of entry of the erroneous data into the dataset, the manufacturer of the product, the supplier of the product, the part number and the product description.

5. A system according to claim 1 comprising a user interface for correcting erroneous data associated with the product comprising fixed options for selection of new data to replace the erroneous data, such as in the form of drop-down menus, whereby preferably the system enables searching through different fields or categories to enable easier selection by an operative of the correct data.

6. A system according to claim 1 whereby a product is uniquely identified using at least two data fields associated with the product such as both the accurately determined manufacturer as identified by a unique manufacturer reference within the database, and the manufacturer's product code, as represented by the original manufacturer's product code and/or an alias thereof which alias is then universally applied for all products held within usable datasets of the system.

7. A system according to claim 1 comprising mapping functionality enabling association of a unique manufacturer's code with a product and/or enabling association of a unique manufacturers product code with the product data held within the system.

8. A system according to claim 1 comprising mapping functionality enabling association of a unique manufacturer's product code with the product using look-up data, for example in a table, to compare one or more fields of data in order to map (or match) incoming data with a correct manufacturer's part number, and thereafter to amend the incoming data so as to include the correct manufacturer's part number.

9. A system according to claim 1, wherein the system is further able to provide mapping functionality enabling association of a unique manufacturer's product code with a product using look-up data, for example in a table, to compare one or more fields of data in order to map incoming data with a correct manufacturer's part number, and thereafter to amend the incoming data so as to include the manufacturer's part number within the data held in the system and associated with the product from the relevant source.

10. A system according to claim 9 wherein the look-up data comprises a field of data representative of common errors in the form of the manufacturer's part number.

11. A system according to claim 10 wherein a common error is automatically generated for a product using a combination of alpha numeric strings to form a string having a predictable error pattern.

12. A system according to claim 1 wherein a first user is able to select a product from a dataset based on one or more selection criteria, such as stock levels and/or price, and to order the product in anticipation of delivery thereof, whereby the system is adapted to detect a failure in an order for example due to low stock levels from a source, and to request updated information from one or more sources related to the ordered product.

13. A system according to claim 1 wherein a first user is able to select a product from a dataset held within the system based on at least one selection criteria, such as stock levels and/or price, and to order the product in anticipation of delivery thereof, whereby the system is adapted further to detect a failure in an order for example due to low stock levels from a source, and to request updated information from one or more sources related to the ordered product.

14. (canceled)

15. A method for obtaining and verifying data from a plurality of remote sources via one or more communications channels or networks, each source having a database of product information comprising a plurality of fields of data associated with products available from the source, the method enabling; analysis of the data from each of the sources to determine a common product identifier for each product, comparison of the determined common product identifier with a predetermined set of common product identifiers and in the event of a failure to match the common product identifiers, enabling an effective alert to a user that the data associated with a product is invalid for example by rejecting the data, placing the data in a special dataset and/or effecting a message to a user of the failure.

16. A method according to claim 15 comprising the steps of processing data and storing erroneous data associated with a product in a separate dataset to a main dataset for data determined to be acceptable, whereby the erroneous dataset comprises only data for products having an erroneous field of data associated therewith.

17. A method according to claim 16 of enabling an operative to select data held within a dataset of erroneous data erroneous database for correction based on one or more criteria.

18. A method according to claim 17 wherein the selection criteria is selectable from one or more of selection of a period of entry of the erroneous data into the dataset, the manufacturer of the product, the supplier of the product, the part number and/or the product description.

19. A method according to claim 15 comprising the step of enabling a user to interface with data for correcting erroneous data associated with the product comprising fixed options for selection of new data to replace the erroneous data, such as in the form of drop-down menus, whereby preferably the method enables searching through different fields or categories to enable easier selection by an operative of the correct data.

20. A method according to claim 15 whereby a product is uniquely identified using at least two data fields associated with the product such as both the accurately determined manufacturer as identified by a unique manufacturer reference within the database, and the manufacturer's product code, as represented by the original manufacturer's product code and/or an alias thereof which alias is then universally applied for all products held within usable datasets of the system.

21. A method according to claim 15 comprising mapping functionality enabling association of a unique manufacturer's code with a product and/or enabling association of a unique manufacturers product code with the product data.

22. A method according to claim 15 comprising mapping functionality enabling association of a unique manufacturer's product code with the product using look-up data, table, to compare one or more fields of data in order to map (or match) incoming data with a correct manufacturer's part number, and thereafter to amend the incoming data so as to include the correct manufacturer's part number.

23. A method according to claim 14, the method further enabling association of a unique manufacturer's product code with a product using look-up data, for example in a table, to compare one or more fields of data in order to map incoming data with a correct manufacturer's part number, and thereafter to amend the incoming data so as to include the manufacturer's part number within the data held in the system and associated with the product from the relevant source.

24. A method according to claim 22 wherein the look-up data comprises a field of data representative of common errors in the form of the manufacturer's part number.

25. A method according to claim 24 wherein a common error is automatically generated for a product using a combination of alpha numeric strings to form a string having a predictable error pattern.

26. A method according to claim 15 wherein a first user is able to select a product from a dataset based on one or more selection criteria, such as stock levels and/or price, and to order the product in anticipation of delivery thereof, whereby the method is adapted to detect a failure in an order for example due to low stock levels from a source, and to request updated information from one or sources related to the ordered product.

27. A method according to claim 14 wherein a first user is able to select a product from a dataset held within the system based on one or more selection criteria, such as stock levels and/or price and to order the product in anticipation of delivery thereof, whereby the system is adapted further to detect a failure in an order for example due to low stock levels from a source, and to request updated information from one or more sources related to the ordered product.

28. (canceled)

29. A computer program product comprising instructional data loadable into a computer system which enables the computer system to effect a method for obtaining and verifying data from a plurality of remote sources via one or more communications channels or networks, each source having a database of product information comprising a plurality of fields of data associated with products available from the source, the method enabling; analysis of the data from each of the sources to determine a common product identifier for each product, comparison of the determined common product identifier with a predetermined set of common product identifiers and in the event of a failure to match the common product identifiers, enabling an effective alert to a user that the data associated with a product is invalid for example by rejecting the data, placing the data in a special dataset and/or effecting a message to a user of the failure.

30. (canceled)
